(19) United States
(12) Patent Application Publication
(10) Pub. No.: US 2016/0053176 A1
(43) Pub. Date: Feb. 25, 2016

(54) COMPOSITION FOR FORMING OPTICALLY ANISOTROPIC LAYER

(71) Applicant: SUMITOMO CHEMICAL COMPANY, LIMITED, Tokyo (JP)

(72) Inventor: Tadahiro KOBAYASHI, Osaka-shi, Osaka (JP)

(73) Assignee: SUMITOMO CHEMICAL COMPANY, LIMITED, Tokyo (JP)

(21) Appl. No.: 14/783,287

(22) PCT Filed: Apr. 10, 2014
(86) PCT No.: PCT/JP2014/060886

§ 371 Date: Oct. 8, 2015

(30) Foreign Application Priority Data
Apr. 11, 2013 (JP) 2013-082697

(51) Int. Cl. C09K 19/30; G02B 5/30; G02B 1/04; B05D 3/06

(52) U.S. Cl. CPC C09K 19/3068; B05D 3/067; G02B 5/3016; G02B 1/04

(57) ABSTRACT

A composition is provided for forming an optically anisotropic layer. The composition includes a polymerizable liquid crystal compound, a photopolymerization initiator, and an ester solvent having a boiling point of 120° C. to 200° C. and a vapor pressure of 0.7 kPa or less.

### TECHNICAL FIELD

The present invention relates to a composition for forming an optically anisotropic layer.

### BACKGROUND ART

A flat panel display device (FPD) makes use of a member including an optically anisotropic film such as a polarizing plate or a retardation plate. As such an optically anisotropic film, known is an optically anisotropic film produced by coating a composition containing polymerizable liquid crystal compound onto a substrate. For example, Patent Document 1 describes an optically anisotropic film formed by coating a composition for forming an optically anisotropic layer made of polymerizable liquid crystal compound, a photopolymerization initiator and a solvent with a boiling point of less than 120° C. onto a substrate subjected to orienting treatment, thereby obtaining a coating layer, and polymerizing the polymerizable liquid crystal compound in the coating layer.

### PRIOR ART DOCUMENT

### Patent Document

Patent Document 1: JP-A-2007-148098

### SUMMARY OF THE INVENTION

### Problems to be Solved by the Invention

An optically anisotropic film produced by coating a conventional composition for forming an optically anisotropic layer onto a substrate has a problem of the reduction of transparency due to drying unevenness caused when drying a solvent.

### Means for Solving the Problems

The present invention includes the following inventions.

[1] A composition for forming an optically anisotropic layer including polymerizable liquid crystal compound, a photopolymerization initiator, and an ester solvent with a boiling point of 120° C. to 200° C. and a vapor pressure of 0.7 kPa or less.
[2] The composition for forming an optically anisotropic layer according to item [1], wherein the ester solvent is at least one kind selected from the group consisting of 2-methoxyethyl acetate, 2-ethoxyethyl acetate, and ethyl acetoacetate.
[3] The composition for forming an optically anisotropic layer according to item [1] or [2], wherein the content of the ester solvent is from 10% by mass to 95% by mass, related to the composition for forming an optically anisotropic layer.
[4] The composition for forming an optically anisotropic layer according to any of items [1] to [3], further including a compound having an isocyanate group.
[5] An optically anisotropic film obtained by coating the composition for forming an optically anisotropic layer according to any of items [1] to [4] onto a surface of an orientation layer to polymerize the polymerizable liquid crystal compound contained in the composition for forming an optically anisotropic layer.
[6] The optically anisotropic film according to item [5], which is a retardation film.
[7] The optically anisotropic film according to item [5] or [6], wherein the arithmetic average roughness of the surface is 100 nm or less.
[8] The optically anisotropic film according to any of items [5] to [7], which is for an in-plane switching (IPS) liquid crystal display device.
[9] A polarizing plate having the optically anisotropic film according to any of items [5] to [8].
[10] A display device, including the optically anisotropic film according to any of items [5] to [8].
[11] A laminated body having a substrate, an orientation layer, and the optically anisotropic film according to any of items [5] to [8], in this order.
[12] The laminated body according to item [11], wherein the substrate is a polyolefin resin.
[13] A method for producing a laminated body including coating the composition for forming an optically anisotropic layer as defined in any of items [1] to [4] onto the surface of an orientation layer of a substrate with the orientation layer, drying, and photoirradiating it.
[14] A polarizing plate having the laminated body according to item [11] or [12].
[15] A display device including the laminated body according to item [11] or [12].

### Effect of the Invention

According to the present invention, an optically anisotropic film having high transparency can be produced.

### BRIEF DESCRIPTION OF THE DRAWINGS

FIGS. 1(a) to 1(e) are each a schematic view illustrating an example of the polarizing plate according to the present invention.

FIGS. 2(a) and 2 (b) are each a schematic view illustrating an example of the liquid crystal display device according to the present invention.

### MODE FOR CARRYING OUT THE INVENTION

The composition for forming an optically anisotropic layer of the present invention contains polymerizable liquid crystal compound, a photopolymerization initiator, and an ester solvent with a boiling point of 120° C. to 200° C. and a vapor pressure of 0.7 kPa or less.

### [Polymerizable Liquid Crystal Compound]

Examples of the polymerizable liquid crystal compound include compounds containing a group represented by a formula (X) (hereinafter, may be referred to as “compound (X)”).

P¹¹—B¹¹-E¹¹-B¹²-A¹¹-B¹³— (X)

wherein P¹¹ represents a polymerizable group;

A¹¹ represents a bivalent alicyclic hydrocarbon group or bivalent aromatic hydrocarbon group provided that any hydrogen atom contained in the bivalent alicyclic hydrocarbon group and bivalent aromatic hydrocarbon group is optionally substituted with a halogen atom, an alkyl group having 1 to 6 carbon atoms, an alkoxy group having 1 to 6 carbon atoms, a cyano group or a nitro group provided that any hydrogen atom contained in the alkyl group having 1 to 6 carbon atoms or the alkoxy group having 1 to 6 carbon atoms is optionally substituted with a fluorine atom;

B¹¹ represents —O—, —S—, —CO—O—, —O—CO—, —O—CO—O—, —CO—NR¹⁶—CO—, —CO—, —CS— or a single bond wherein R¹⁶s each represent a hydrogen atom or an alkyl group having 1 to 6 carbon atoms;

B¹² and B¹² each independently represent —C≡C—, —CH═CH—, —CH₂—CH₂—, —O—, —S—, —C(═O)—, —C(═O)—O—, —O—C(═O)—, —O—C(═O)—O—, —CH═N—, —N═CH—, —N═N—, —C(═O)—NR¹⁶—, —NR¹⁶—C(═O)—, —OCH₂—, —OCF₂—, —CH₂O—, —CF₂O—, —CH═CH—C(═O)—O—, —O—C(═O)—CH═CH—, or a single bond;

E¹¹ represents an alkanediyl group having 1 to 12 carbon atoms provided that any hydrogen atom contained in the alkanediyl group is optionally substituted with an alkoxy group having 1 to 5 carbon atoms provided that any hydrogen atom contained in the alkoxy group is optionally substituted with a halogen atom; and also, any —CH₂— that constitutes the alkanediyl group is optionally replaced with —O— or —CO—.

The number of the carbon atoms of the aromatic hydrocarbon group and alicyclic hydrocarbon group as A¹¹ is preferably in the range of 3 to 18, more preferably in the range of 5 to 12, and particularly preferably 5 or 6. A¹¹ is preferably a cyclohexane-1,4-diyl group or a 1,4-phenylene group.

E¹² is preferably a linear alkanediyl group having 1 to 12 carbon atoms. Any —CH₂— that constitutes the alkanediyl group is optionally replaced with —O—.

Specific examples thereof include linear alkanediyl groups having 1 to 12 carbon atoms, such as methylene, ethylene, propane-1,3-diyl, butane-1,4-diyl, pentane-1,5-diyl, hexane-1,6-diyl, heptane-1,7-diyl, octane-1,8-diyl, nonane-1,9-diyl, decane-1,10-diyl, undecane-1,11-diyl, and dodecane-1,12-diyl groups; —CH₂—CH₂—O—CH₂—CH₂—, —CH₂—CH₂—O—CH₂—CH₂—O—CH₂—CH₂—, and —CH₂—CH₂—O—CH₂—CH₂—O—CH₂—CH₂—O—CH₂—CH₂—; and the like.

B¹¹ is preferably —O—, —S—, —CO—O—, or —O—CO—, and more preferably —CO—O—.

B¹² and B¹³ are each independently preferably —O—, —S—, —C(═O)—, —C(═O)—O—, —O—C(═O)—, or —O—C(═O)—O—, and more preferably —O— or —O—C(═O)—O—.

The polymerizable group represented by P¹¹ is preferably a radical polymerizable group or cation polymerizable group since the group is high in polymerization reactivity, in particular, photopolymerization reactivity. The polymerizable group is preferably a group represented by any one of the following formulae (P-11) to (P-15) since it is easy to handle, and the liquid crystal compound are also easily produced:

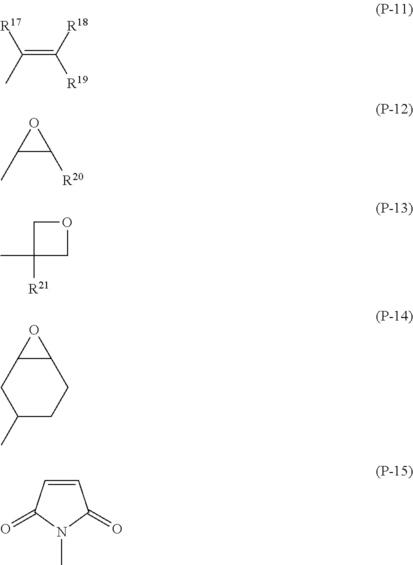

wherein

R¹⁷ to R²¹ each independently represent an alkyl group having 1 to 6 carbon atoms, or a hydrogen atom.

Specific examples of the group represented by any one of the formulae (P-11) to (P-15) include respective groups represented by the following formulae (P-16) to (P-20).

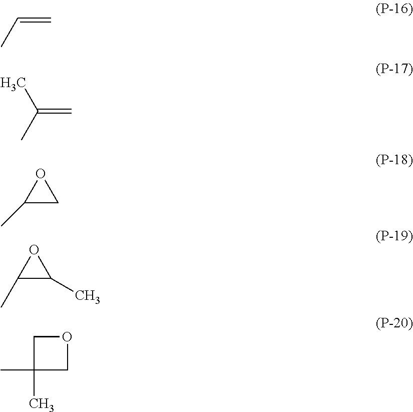

P¹¹ is preferably a group represented by any one of the formulae (P-14) to (P-20), and more preferably a vinyl, p-stilbene group, epoxy or oxetanyl group.

Further preferably, the group represented by P¹¹—B¹¹— is an acryloyloxy or methacryloyloxy group.

Examples of the compound (X) include respective compounds represented by the formulae (I), (II), (III), (IV), (V) or (VI):

P¹¹—B¹¹-E¹¹-B¹²-A¹¹-B¹³-A¹²-B¹⁴-A¹³-B¹⁵-A¹⁴-B¹⁶-E¹²-B¹⁷—P¹² (I)

P¹¹—B¹¹-E¹¹-B¹²-A¹¹-B¹³-A¹²-B¹⁴-A¹³-B¹⁵-A¹⁷-F²¹ (II)

P¹¹—B¹¹-E¹¹-B¹²-A¹¹-B¹³-A¹²-B¹⁴-A¹³-B¹⁵-E¹²-B¹⁷—P¹² (III)

P¹¹—B¹¹-E¹¹-B¹²-A¹¹-B¹³-A¹²-B¹⁴-A¹³-F¹¹ (IV)

P¹¹—B¹¹-E¹¹-B¹²-A¹¹-B¹³-A¹²-B¹⁴-E¹²-B¹⁷—P¹² (V)

P¹¹—B¹¹-E¹¹-B¹²-A¹¹-B¹³-A¹²-F¹¹ (VI)

wherein

A¹² to A¹⁴ each independently have the same meaning as A¹¹; B¹⁴ to B¹⁶ each independently have the same meaning as B¹²; B¹⁷ has the same meaning as B¹¹; and E¹² has the same meaning as E¹¹; and

F¹² represents a hydrogen atom, an alkyl group having 1 to 13 carbon atoms, an alkoxy group having 1 to 13 carbon atoms, a cyano group, a nitro group, a trifluoromethyl group, a dimethylamino group, a hydroxy group, a methylol group, a formyl group, a sulfo group (—SO₃H), a carboxy group, an alkoxycarbonyl group having 1 to 10 carbon atoms, or a halogen atom, provided that any —CH₂— that constitutes the alkyl group and alkoxy group is optionally replaced with —O—.

Specific examples of the polymerizable liquid crystal compound include compounds each having a polymerizable group out of the compounds described in “3.8.6 Network (Completely Crosslinked Type)” and “6.5.1 Liquid Crystal Material, b. Polymerizable Nematic Liquid Crystal Material” in “Liquid Crystal Handbook” (edited by Liquid Crystal Handbook Editorial Committee, and published by Maruzen Publishing Co., Ltd. on Oct. 30, 2000); and polymerizable liquid crystal compound described in JP-A-2010-31223, JP-A-2010-270108, JP-A-2011-6360, and JP-A-2011-207765.

Specific examples of the compound (X) include compounds represented by following formulae (I-1) to (I-4), formulae (II-1) to (II-4), formulae (III-1) to (III-26), formulae (IV-1) to (IV-26), formulae (V-1) to (V-2), and formulae (VI-1) to (VI-6). In the following formulae, k1 and k2 each independently represent an integer of 2 to 12. These compounds (X) are preferred since the compounds are easily synthesized or are easily available.

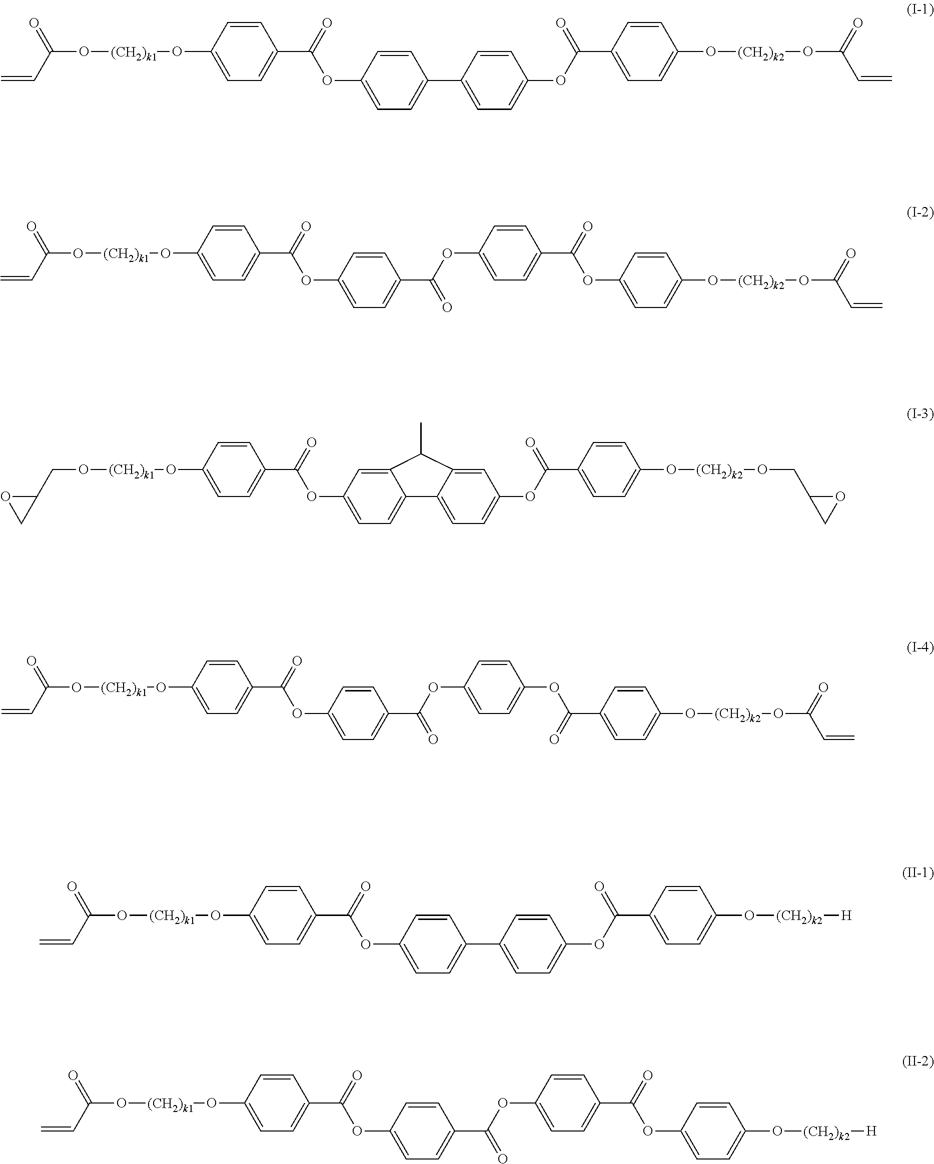

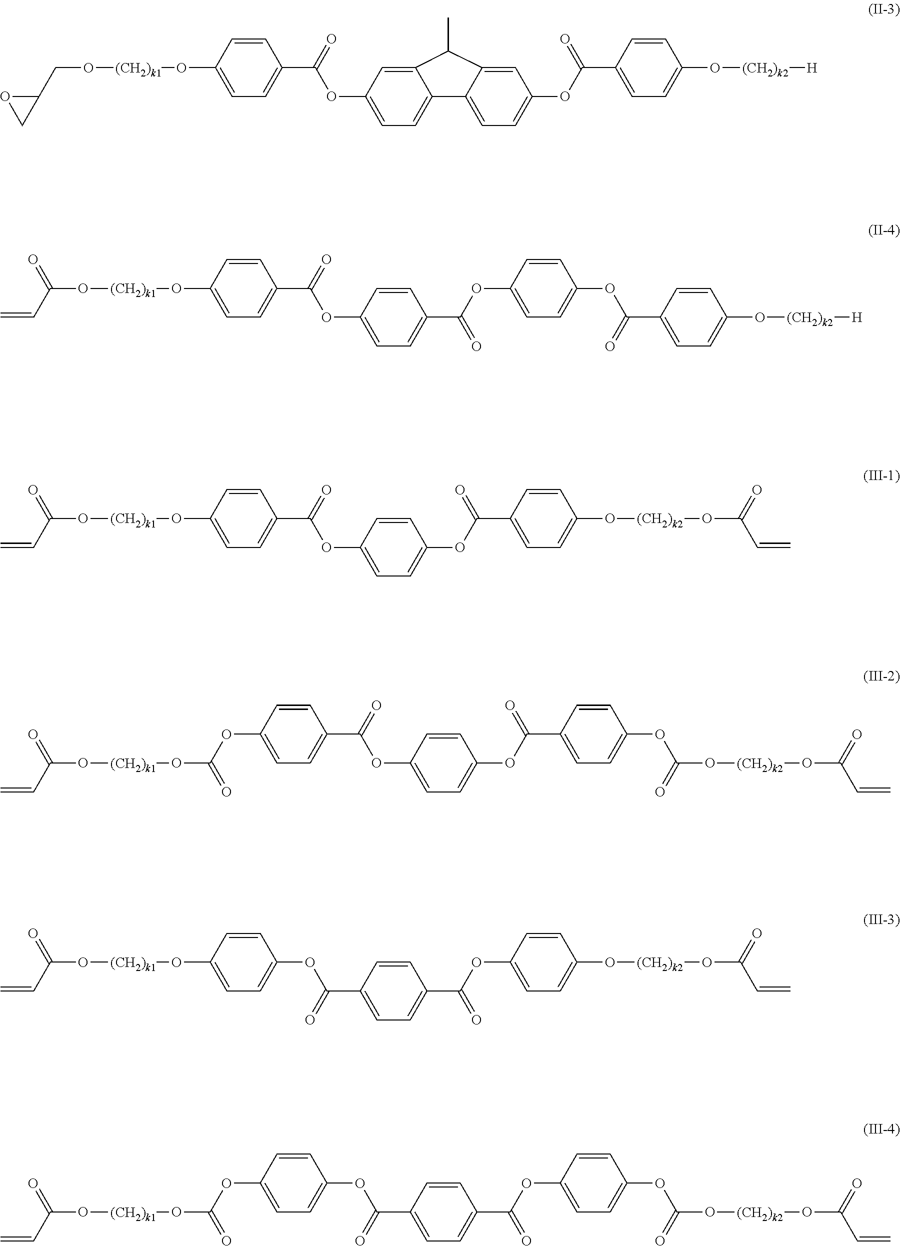

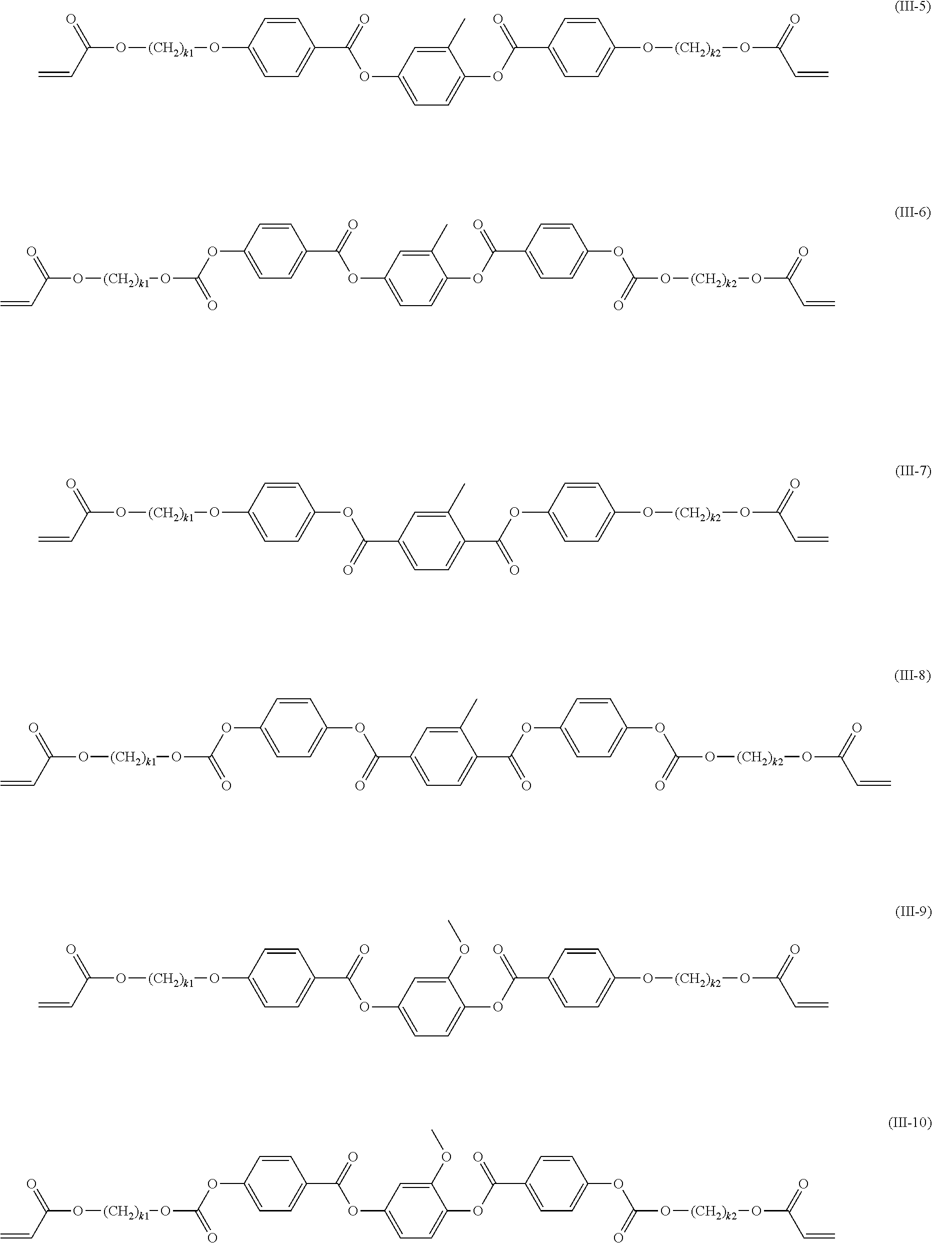

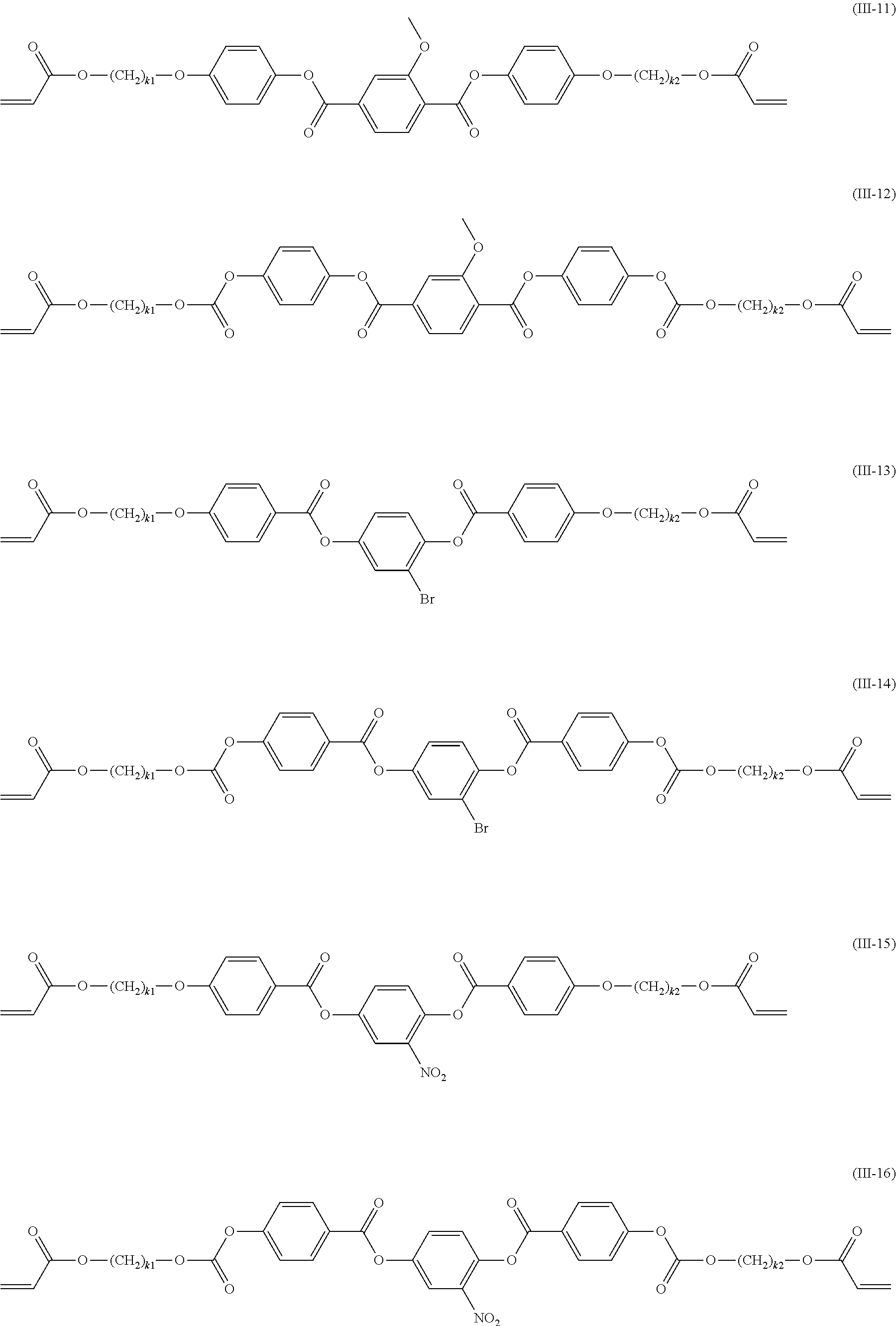

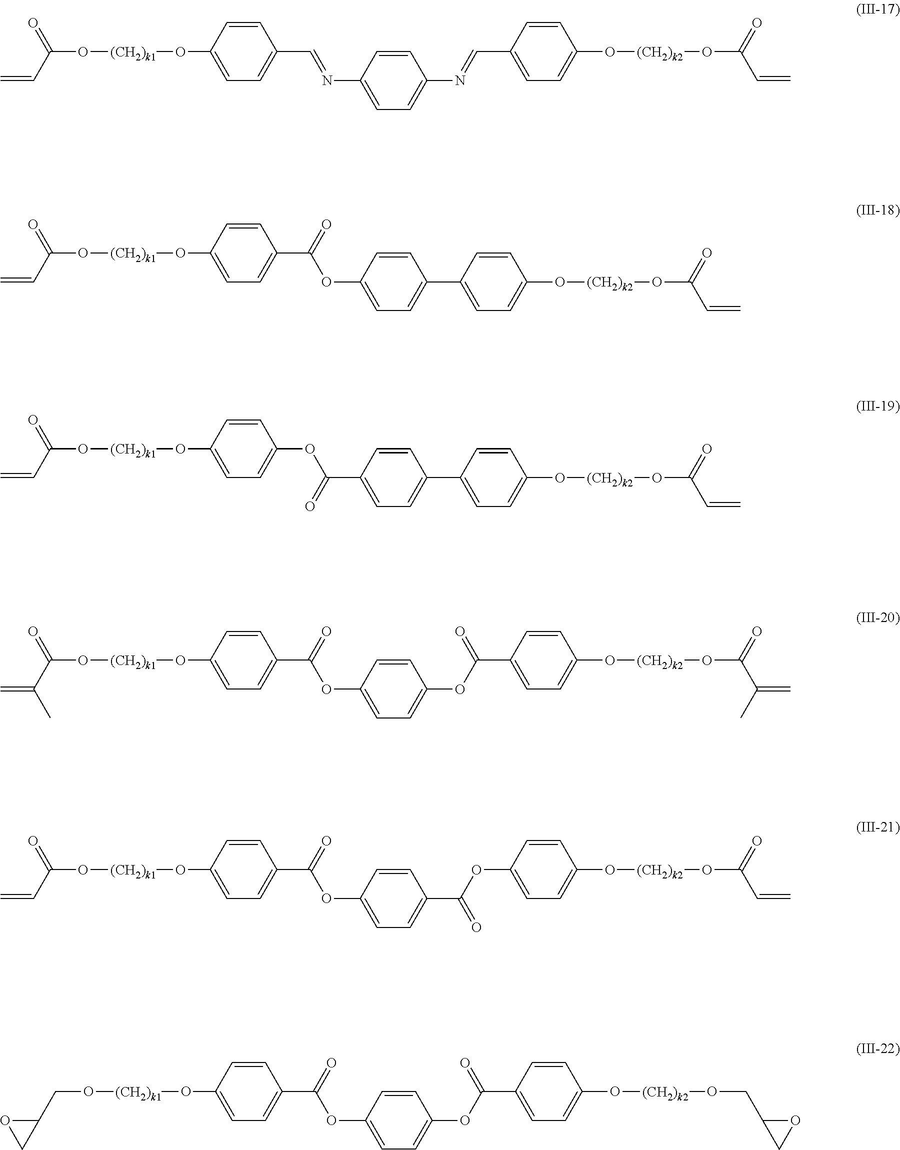

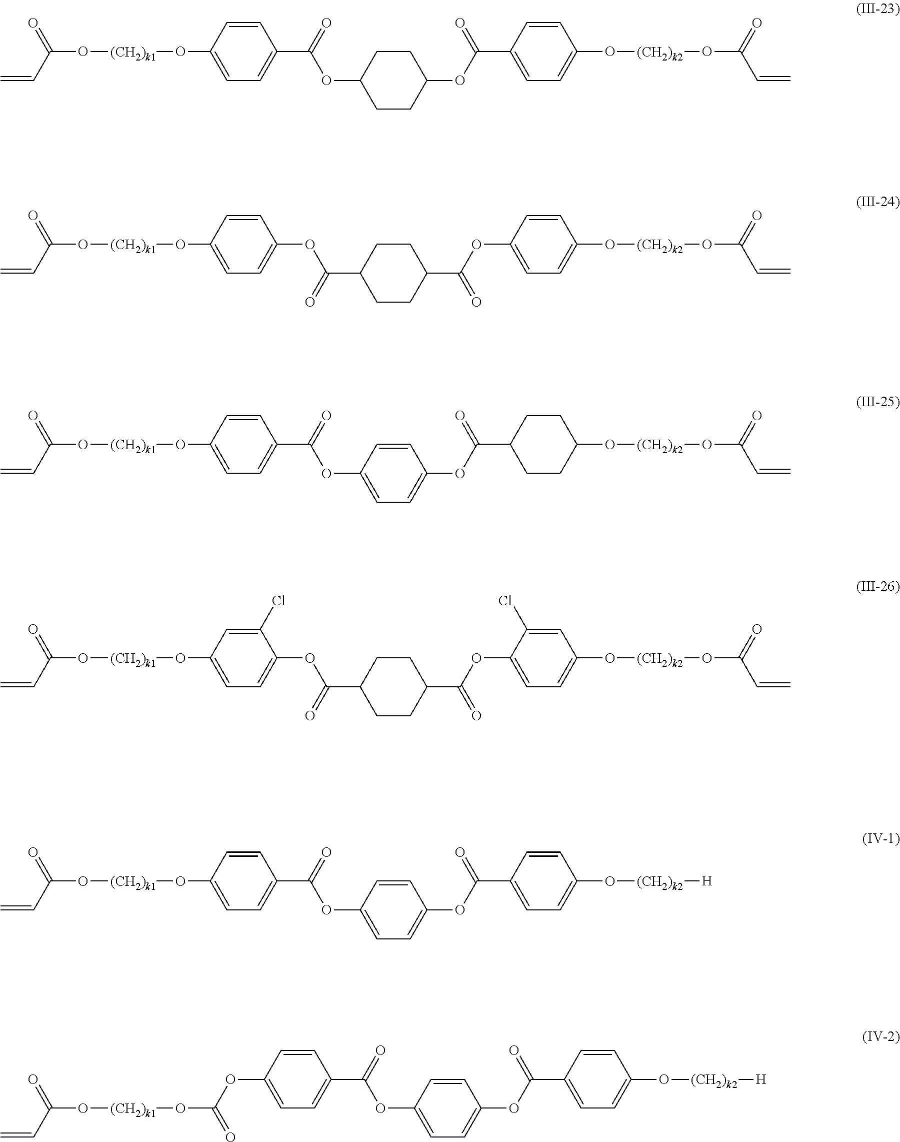

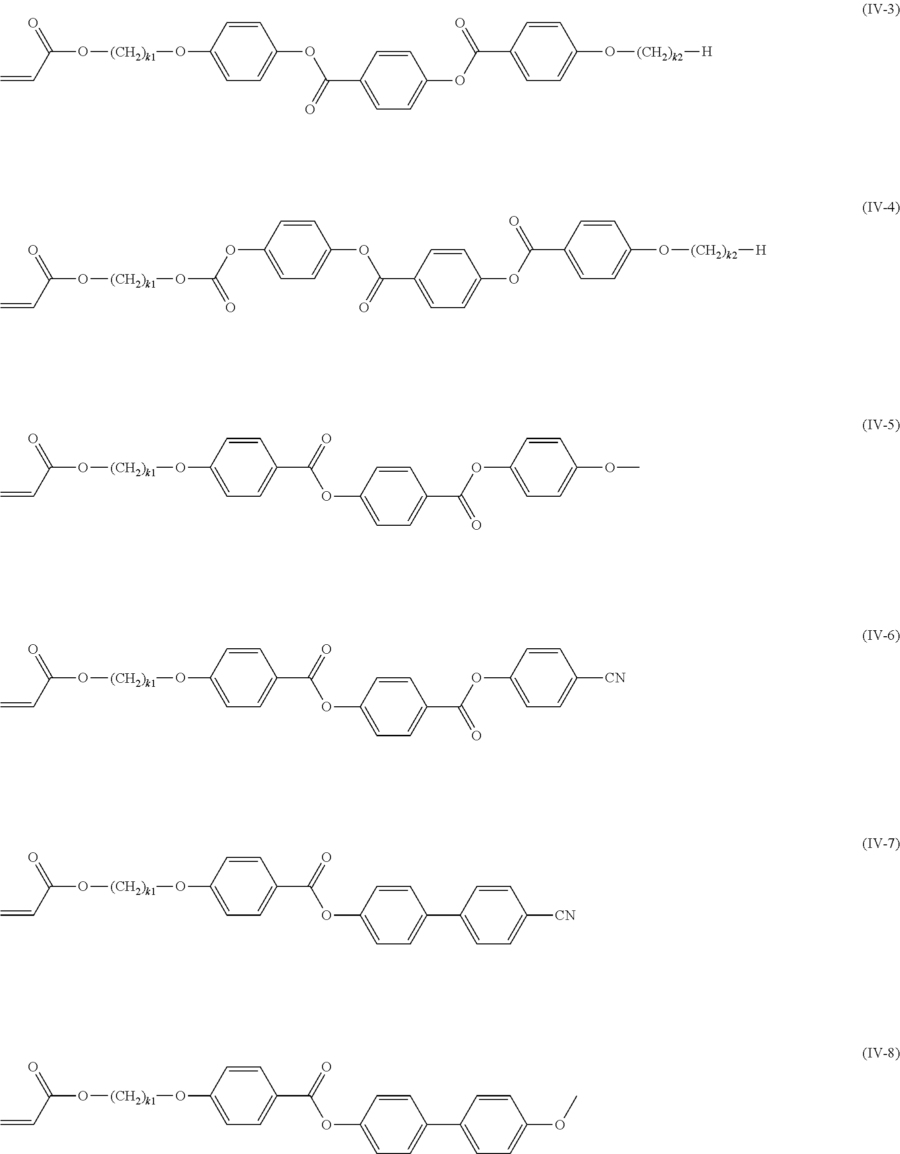

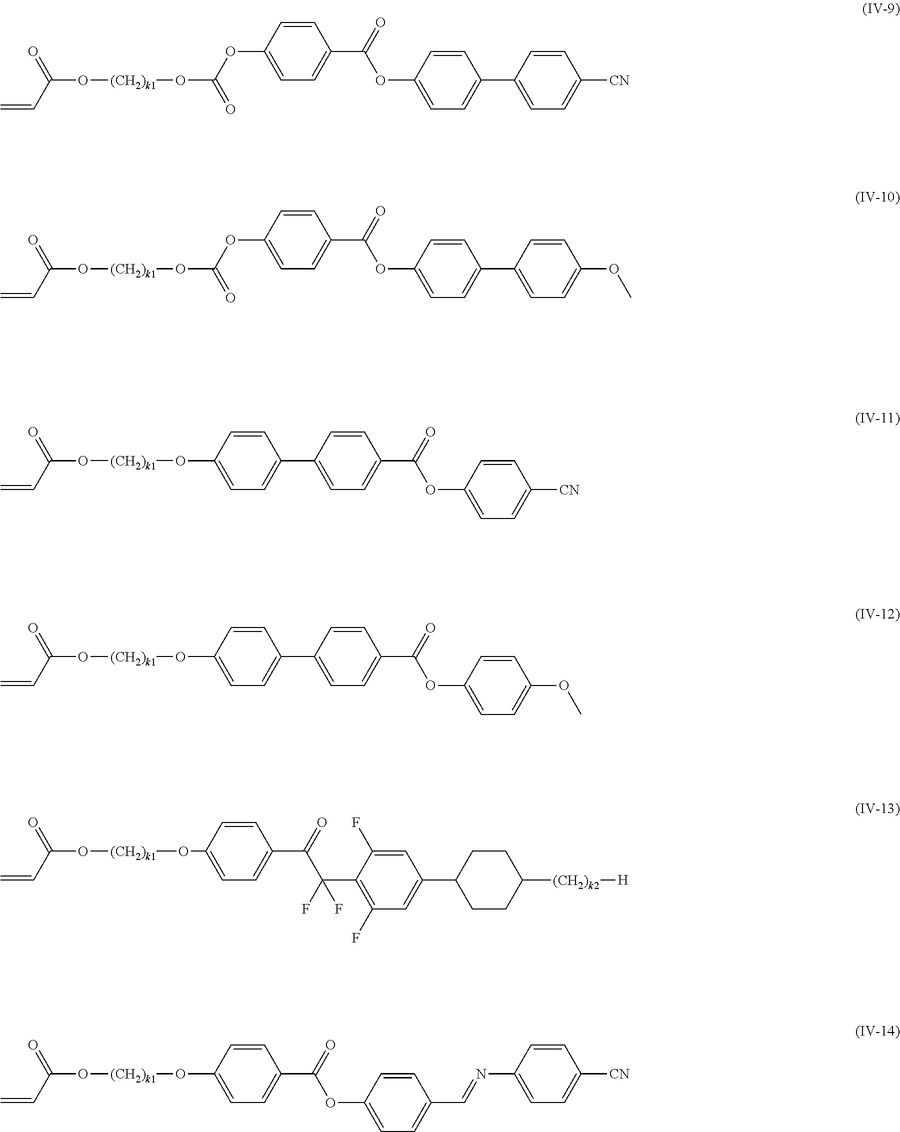

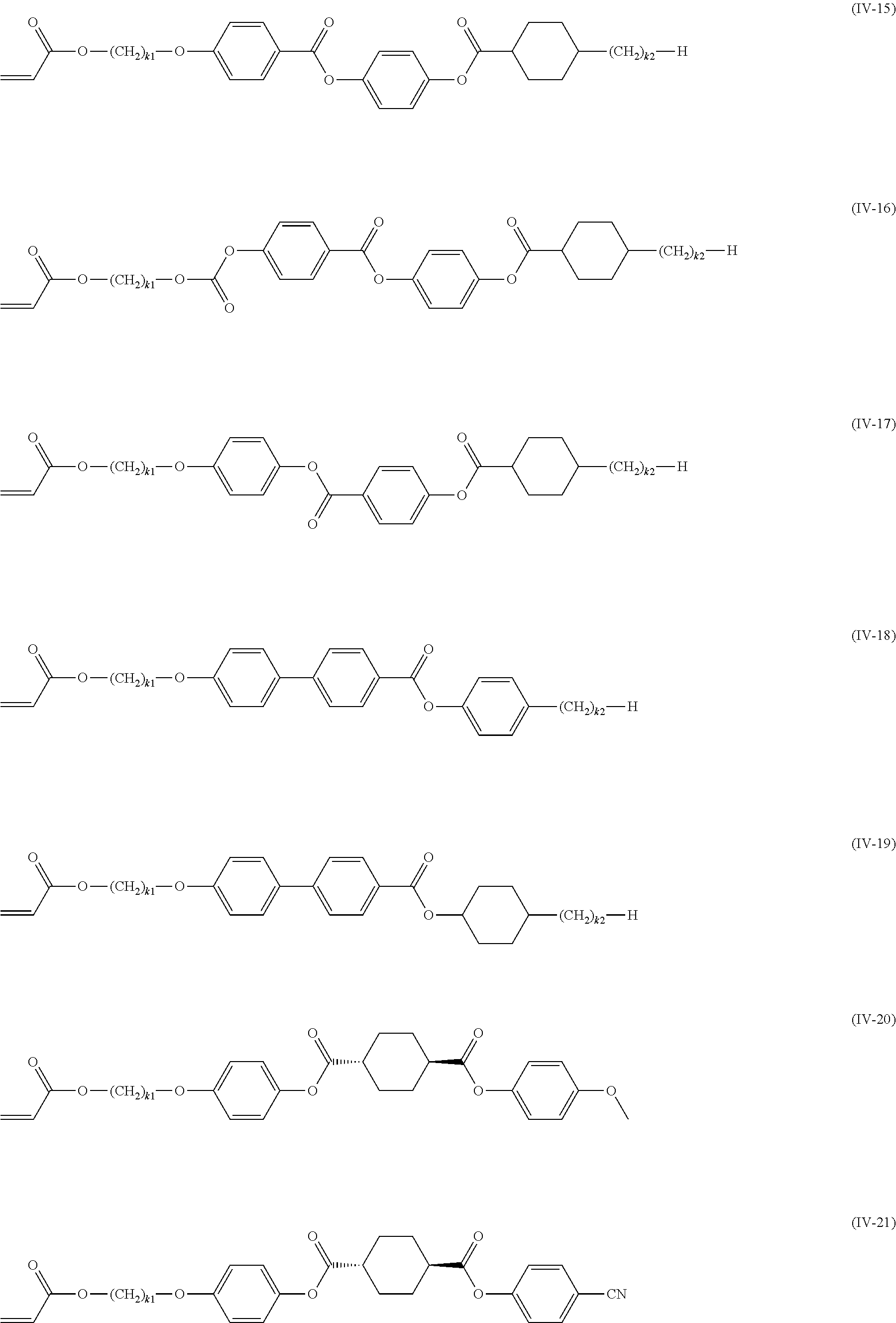

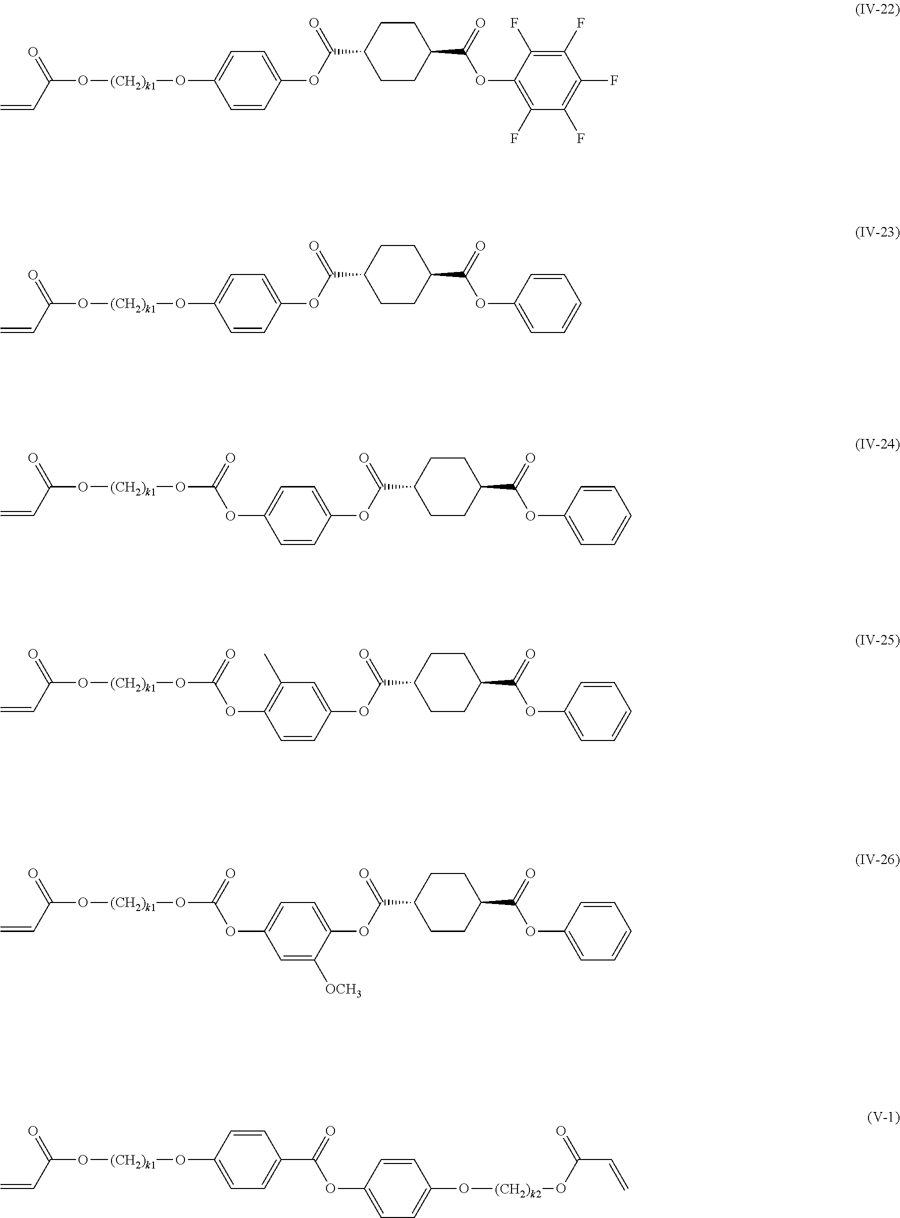

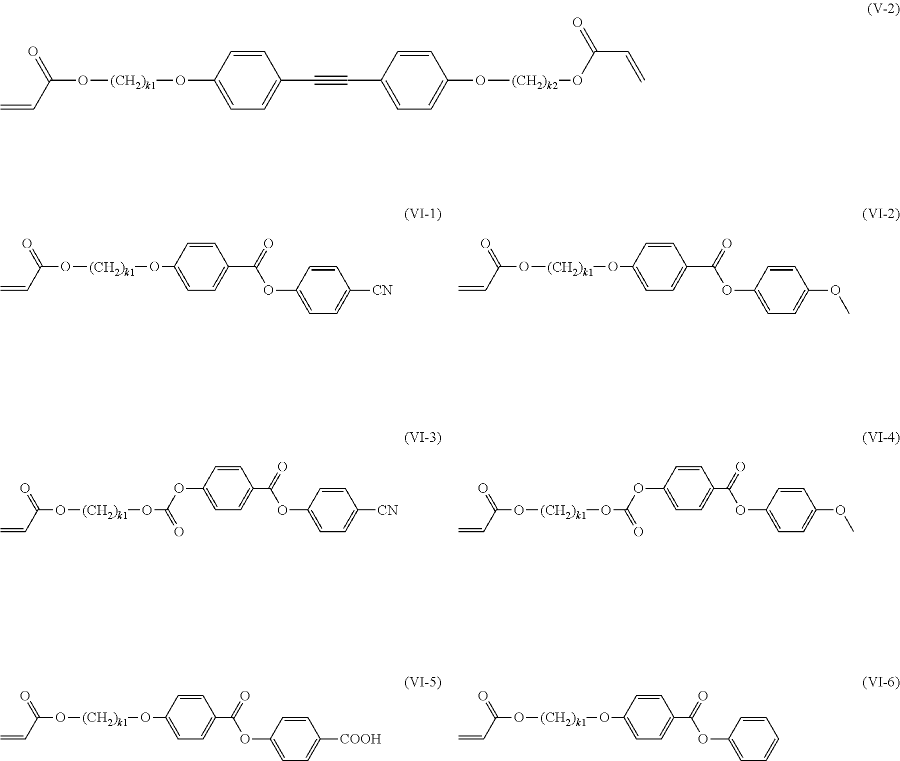

### [Photopolymerization Initiator]

Examples of the photopolymerization initiator include benzoin compounds, benzophenone compounds, benzyl ketal compounds, α-hydroxyketone compounds, α-aminoketone compounds, α-acetophenone compounds, triazine compounds, iodonium salts, and sulfonium salts. Specific examples thereof include IRGACUREs 907, 184, 651, 819, 250 and 369 (all manufactured by Ciba Japan K.K.); SEIKUOLs BZ, Z, and BEE (all manufactured by Seiko Chemical Co., Ltd.); KAYACURE BP100 (manufactured by Nippon Kayaku Co., Ltd.); KAYACURE UVI-6992 (manufactured by the Dow Chemical Company); ADEKA OPTOMERs SP-152 and SP-170 (all manufactured by Adeka Corporation); TAZ-A and TAZ-PP (all manufactured by Nihon Siber Hegner K.K.); and TAZ-104 (manufactured by Sanwa Chemical Co., Ltd.). Among them, preferred are α-acetophenone compounds. Examples of the α-acetophenone compounds include 2-methyl-2-morpholine-1-(4-methylsulfanylphenyl)propan-1-one, 2-dimethylamino-1-(4-morpholinophenyl)-2-benzylbutan-1-one, 2-dimethylamino-1-(4-morpholinophenyl)-2-(4-methylphenylmethyl)butane-1-one, and the like. More preferred are 2-methyl-2-morpholino-1-(4-methylsulfanylphenyl)propane-1-one, and 2-dimethylamino-1-(4-morpholinophenyl)-2-benzylbutan-1-one. Commercially available product examples of the α-acetophenone compounds include IRGACUREs 369, 379EG and 907 (all manufactured by BASF Japan Ltd.), SEIKUOL BEE (manufactured by Seiko Chemical Co., Ltd.), and the like.

The content of the photopolymerization initiator is usually from 0.1 parts by mass to 30 parts by mass, and preferably from 0.5 parts by mass to 10 parts by mass, related to 100 parts by mass of the polymerizable liquid crystal compound. In the above range, the polymerizable liquid crystal compound can be polymerized without disturbing the orientation of the polymerizable liquid crystal compound.

### [Solvent]

The ester solvent herein denotes a carboxylate ester which is a liquid at 23° C. under 1 atm.

Examples of the ester solvent with a boiling point of 120° C. to 200° C. and a vapor pressure of 0.7 kPa or less include ethylene glycol methyl ether acetate, γ-butyrolactone, propylene glycol methyl ether acetate, 2-methoxyethyl acetate, 2-ethoxyethyl acetate, 3-methoxybutyl acetate, 2-ethoxyethyl acetate, ethyl acetoacetate, amyl acetate, ethyl lactate, butyl lactate, isoamyl acetate, and the like. Preferred is 2-methoxyethyl acetate, 2-ethoxyethyl acetate and ethyl acetoacetate, and more preferred is 2-methoxyethyl acetate. Such solvents may be used alone or in combination. By containing these solvents, it is possible to reduce drying unevenness during drying, and form an optically anisotropic layer having more uniformity and excellent transparency.

The boiling point referred herein is a value under 1 atm, and the vapor pressure is a value at 23° C.

The composition for forming an optically anisotropic layer may further contain other solvent.

As other solvent, those improving operability in forming an optically anisotropic film are preferred, and examples include organic solvents. Among them, more preferred is a solvent in which constituent components of the composition for forming an optically anisotropic layer such as the polymerizable liquid crystal compound are soluble, that is inert to the polymerization reaction of the polymerizable liquid crystal compound.

Specific examples of other solvent include alcohol solvents such as methanol, ethanol, ethylene glycol, isopropyl alcohol, propylene glycol, methylcellosolve, butylcellosolve, propylene glycol monomethyl ether, and phenol; ester solvents with a boiling point of less than 120° C. and a vapor pressure of more than 0.7 kPa such as ethyl acetate and butyl acetate; ketone solvents such as acetone, methyl ethyl ketone, cyclopentanone, cyclohexanone, cycloheptanone, methyl amyl ketone, methyl isobutyl ketone, and N-methyl-2-pyrrolidinone; non-chlorinated aliphatic hydrocarbon solvents such as pentane, hexane, and heptane; non-chlorinated aromatic hydrocarbon solvents such as toluene and xylene; nitrile solvents such as acetonitrile; ether solvents such as propylene glycol monomethyl ether, tetrahydrofuran, and dimethoxyethane; and chlorinated hydrocarbon solvents such as chloroform and chlorobenzene. Such other solvents may be used alone or in combination.

The content of the ester solvent with a boiling point of 120° C. to 200° C. and a vapor pressure of 0.7 kPa or less is usually 10% by mass to 95% by mass, preferably 10% by mass to 90% by mass, and more preferably 50% by mass to 85% by mass, related to the composition for forming an optically anisotropic layer.

The content of other organic solvent is usually preferably from 10 parts by mass to 10000 parts by mass, and more preferably from 50 parts by mass to 5000 parts by mass, related to 100 parts by mass of the solid content. The solid content means the entire components excluding the solvent from the composition for forming an optically anisotropic layer.

The solid concentration in the composition for forming an optically anisotropic layer is preferably from 1% by mass to 50% by mass, more preferably from 2 to 50% by mass, and further preferably from 5% by mass to 50% by mass.

The content ratio of the ester solvent with a boiling point of 120° C. to 200° C. and a vapor pressure of 0.7 kPa or less to other solvent is usually 1000:1 to 5:1, and preferably 100:1 to 10:1, expressed as ester solvent:other solvent.

### [Reactive Additive]

The composition for forming an optically anisotropic layer of the present invention preferably contains a reactive additive.

By containing a reactive additive, adhesion between the optically anisotropic film and the orientation layer in the laminated body of the present invention is improved, and a laminated body in which peeling during processing is suppressed can be obtained.

The reactive additive is preferably a compound having in the molecule thereof a carbon-carbon unsaturated bond and an active hydrogen reactive group. The “active hydrogen reactive group” herein means a group reactive with a group having active hydrogen such as a carboxyl group (—COOH), hydroxyl group (—OH) or amino group (—NH₂). Typical examples thereof are glycidyl, oxazoline, carbodiimide, aziridine, imide, isocyanate, thioisocyanate, maleic anhydride groups, and the like. The number of the carbon-carbon unsaturated bond and the active hydrogen reactive group in which the reactive additive has is usually 1 to 20 each, and preferably 1 to 10 each.

It is preferred that the reactive additive has at least two active hydrogen reactive groups. In this case, a plurality of the active hydrogen reactive groups may be the same as or different from each other.

The carbon-carbon unsaturated bond that the reactive additive has may be a carbon-carbon double bond, a carbon-carbon triple bond, or a combination of the two, and is preferably a carbon-carbon double bond. Among them, it is preferred that the reactive additive contains a carbon-carbon unsaturated bond as a vinyl group and/or a (meth)acrylic group. Furthermore, the reactive additive is preferably a compound having, as its active hydrogen reactive group(s), at least one selected from the group consisting of epoxy, glycidyl and isocyanate groups; and is particularly preferably a reactive additive having an acrylic group and an isocyanate group.

Specific examples of the reactive additive include compounds each having a (meth) acrylic group and an epoxy group, such as methacryloxy glycidyl ether and acryloxy glycidyl ether; compounds each having a (meth)acrylic group and an oxetane group, such as oxetane acrylate and oxetane methacrylate; compounds each having a (meth)acrylic group and a lactone group, such as lactone acrylate and lactone methacrylate; compounds each having a vinyl group and an oxazoline group, such as vinyl oxazoline and isopropenyl oxazoline; oligomers of a compound having a (meth) acrylic group and an isocyanate group, such as isocyanatomethyl acrylate, isocyanatomethyl methacrylate, 2-isocyanatoethyl acrylate, and 20 isocyanatoethyl methacrylate, and the like. Also, other examples thereof include compounds each having a vinyl group or vinylene group and an acid anhydride, such as methacrylic anhydride, acrylic anhydride, maleic anhydride, and vinylmaleic anhydride, and the like. Among them, preferred are methacryloxy glycidyl ether, acryloxy glycidyl ether, isocyanatomethyl acrylate, isocyanatomethyl methacrylate, vinyl oxazoline, 2-isocyanatoethyl acrylate, 2-isocyanatoethyl methacrylate, and the above-mentioned oligomers. Particularly preferred are isocyanatomethyl acrylate, 2-isocyanatoethyl acrylate, and the above-mentioned oligomers.

Specifically, preferred is a compound represented by the following formula (Y):

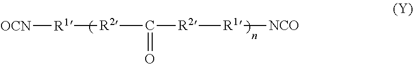

wherein

n represents an integer of 1 to 10, R^{1′}s each represent a bivalent aliphatic or alicyclic hydrocarbon group having 2 to 20 carbon atoms, or a bivalent aromatic hydrocarbon group having 5 to 20 carbon atoms; one of two R^{2′}s in each of the recurring units is a group represented by —NH— and the other is a group represented by >N—C(═O)—R^{3′} wherein R^{3′} represents a hydroxyl group or a group having a carbon-carbon unsaturated bond; and

at least one of R³'s in the formula (Y) is a group having a carbon-carbon unsaturated bond.

Of the reactive additives represented by the formula (Y), particularly preferred is a compound represented by the following formula (YY) in which n has the same meaning as described above (hereinafter, the compound may be referred to as “compound (YY)”):

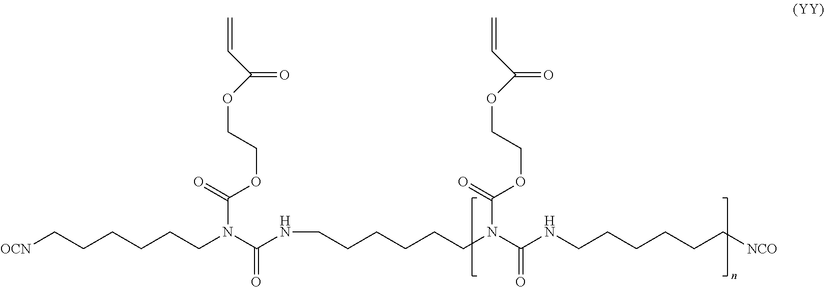

As the compound (YY), a commercially available product is usable as it is, or after being purified if necessary. Examples of the commercially available product include Laromer (registered trademark) LR-9000 (manufactured by BASF).

Adhesion can be evaluated by an adhesion test in accordance with JIS-K5600. For example, it is advisable to perform the adhesion test, using a commercially available device, such as a Cross-Cut Guide I Series device (CCI-1; a device for 25 squares having intervals of 1 mm) manufactured by COTEC CORPORATION.

For example, the adhesion test is performed using a Cross-Cut Guide I Series device (CCI-1; a device for 25 squares having intervals of 1 mm), and it can be judged that the adhesion is high when the number of squares in each of which the orientation layer in which the optically anisotropic film is formed is held without being peeled from the resin substrate, out of the 25 squares, is 9 or more, and 36% or more by area is not peeled from the resin substrate.

The content of the reactive additive is usually from 0.1 parts by mass to 30 parts by mass, and preferably from 0.1 parts by mass to 5 parts by mass, related to 100 parts by mass of the polymerizable liquid crystal compound.

The composition for forming an optically anisotropic layer may contain a polymerization inhibitor, a photosensitizer, a leveling agent, a chiral agent, and the like, in addition to the above.

### [Polymerization Inhibitor]

The polymerization inhibitor can attain the control of the polymerization reaction of the polymerizable liquid crystal compound.

Examples of the polymerization inhibitor include hydroquinone and hydroquinones each having a substituent such as an alkyl ether; catechols each having a substituent such as an alkyl ether, such as butylcatechol; radical scavengers such as pyrogallols and 2,2,6,6-tetramethyl-1-piperidinyloxy radicals; thiophenols; β-naphthylamines; and β-naphthols.

The content of the polymerization inhibitor in the composition for forming an optically anisotropic layer is usually from 0.1 parts by mass to 30 parts by mass, and preferably from 0.5 parts by mass to 10 parts by mass, related to 100 parts by mass of the polymerizable liquid crystal compound. It is preferred in the above range since the polymerizable liquid crystal compound can be polymerized without disturbing the orientation of the polymerizable liquid crystal compound.

### [Photosensitizer]

Examples of the photosensitizer include xanthones such as xanthone and thioxanthone; anthracene, and anthracenes such as anthracene having a substituent such as an alkyl ether; phenothiazine; and rubrene.

The photosensitizer makes it possible to heighten the sensitivity of the photopolymerization initiator. The content of the photosensitizer is usually from 0.1 parts by mass to 30 parts by mass, and preferably from 0.5 parts by mass to 10 parts by mass, related to 100 parts by mass of the polymerizable liquid crystal compound.

### [Leveling Agent]

Examples of the leveling agent include organic modified silicone oil-based, polyacrylate-based, and perfluoroalkyl-based leveling agents. Specific examples thereof include DC3PA, SH7PA, DC11PA, SH28PA, SH29PA, SH30PA, ST80PA, ST86PA, SH8400, SH8700 and FZ2123 (all manufactured by Dow Corning Toray Co., Ltd.); KP321, KP323, KP324, KP326, KP340, KP341, X22-161A and KF6001 (all manufactured by Shin-Etsu Chemical Co., Ltd.); TSF400, TSF401, TSF410, TSF4300, TSF4440, TSF4445, TSF-4446, TSF4452 and TSF4460 (all manufactured by Momentive Performance Materials Inc.), FLUORINERTs (registered trademark) FC-72, FC-40, FC-43 and FC-3283 (all manufactured by Sumitomo 3M Limited); MEGAFACs (registered trademark) R-08, R-30, R-90, F-410, F-411, F-443, F-445, F-470, F-477, F-479, F-482 and F-483 (all manufactured by DIC Corporation); EFTOPs (trade name) EF301, EF303, EF351 and EF352 (all manufactured by Mitsubishi Materials Electronic Chemicals Co., Ltd.); SURFLONs (registered trademark) S-381, S-382, S-383, S-393, SC-101, SC-105, KH-40 and SA-100 (all manufactured by AGC Seimi Chemical Co., Ltd.); trade names of E1830 and E5844 (manufactured by Daikin Fine Chemical Laboratory Co., Ltd.); and BM-1000, BM-1100, BYK-352, BYK-353 and BYK-361N (all manufactured by BM Chemie GmbH). Such leveling agents may be used in any combination of two or more thereof.

It is possible to form a smoother optically anisotropic film by the leveling agent. Also, it is possible to control the fluidity of the composition for forming an optically anisotropic layer or adjust the crosslinking density of the optically anisotropic layer in the production process of the optically anisotropic film. The content of the leveling agent is usually from 0.1 parts by mass to 30 parts by mass, and preferably from 0.1 parts by mass to 10 parts by mass, related to 100 parts by mass of the polymerizable liquid crystal compound.

### [Chiral Agent]

Examples of the chiral agent include known chiral agents (for example, agents described in “Liquid Crystal Device Handbook”, Chapter 3, 4-3, Chiral Agents for TN and STN, p. 199, edited by Japan Society for the Promotion of Science, the 142nd Committee, 1989).

The chiral agent generally contains an asymmetric carbon atom, but an axially asymmetric compound or planarly asymmetric compound, which contains no asymmetric carbon atom, can be also used as the chiral agent. Examples of the axially asymmetric compound or planarly asymmetric compound include binaphthyl, helicene, paracyclophane, and derivatives of these compounds.

Specific examples thereof include compounds as described in JP-A-2007-269640, JP-A-2007-269639, JP-A-2007-176870, JP-A-2003-137887, JP-W-2000-515496, JP-A-2007-169178, and JP-W-09-506088. Preferred is Paliocolor (registered trademark) LC756 manufactured by BASF Japan Ltd.

When the chiral agent is used, the content thereof is usually from 0.1 parts by mass to 30 parts by mass, and preferably from 1.0 parts by mass to 25 parts by mass, related to 100 parts by mass of the polymerizable liquid crystal compound. It is preferred in the above range since the polymerizable liquid crystal compound can be polymerized without disturbing the orientation of the polymerizable liquid crystal compound.

The optically anisotropic film of the present invention is obtained by coating the composition for forming an optically anisotropic layer onto the surface of the orientation layer to polymerize polymerizable liquid crystal compound contained in the composition for forming an optically anisotropic layer.

An orientation layer is usually formed on the substrate.

A transparent substrate is usually used as the substrate. The transparent substrate means a substrate having such a translucency that light, in particular, visible rays can be transmitted through the substrate. Translucency denotes a property that the transmittance to light rays having wavelengths from 380 nm to 780 nm is 80% or more. Specific examples of the transparent substrate include glass and translucent resin substrates, and preferred is a translucent resin substrate. As the substrate, a substrate in the form of a film is usually used.

Examples of the resin that constitutes the translucent resin substrate include polyolefins such as polyethylene, polypropylene, and norbornene-based polymers; polyvinyl alcohol; polyethylene terephthalate; polymethacrylates; polyacrylates; cellulose esters; polyethylene naphthalate; polycarbonates; polysulfones; polyethersulfones; polyetherketones; polyphenylenesulfides; polyphenylene oxides; and the like. Among them, the resin is preferably a substrate made of polyolefin such as polyethylene, polypropylene, or norbornene-based polymer.

The substrate may be subjected to surface treatment. Examples of the method for the surface treatment include a method of treating a surface of the substrate with corona or plasma in a vacuum or an atmospheric pressure; a method of treating a surface of the substrate with a laser; a method of treating a surface of the substrate with ozone; a method of subjecting a surface of the substrate to saponifying treatment or a method of subjecting a surface of the substrate to flame treatment; a method of coating a coupling agent onto a surface of the substrate to subject to primer treatment; a graft-polymerization method of causing a reactive monomer or a polymer having reactivity to adhere onto a surface of the substrate, and then irradiating the monomer or polymer with radial rays, plasma or ultraviolet rays to cause a reaction of the monomer or polymer; and the like. Among them, preferred is the method of treating a surface of the substrate with corona or plasma in a vacuum or an atmospheric pressure.

Examples of the method of treating a surface of the substrate with corona or plasma include

a method of setting the substrate between opposed electrodes under a pressure close to the atmospheric pressure, and generating corona or plasma to treat the surface of the substrate therewith;

a method of causing a gas to flow into the gap between opposed electrodes, making the gas into plasma between the electrodes, and blowing the plasma-state gas onto the substrate; and

a method of generating glow discharge plasma under a low pressure to treat the surface of the substrate therewith.

Among them, preferred are the method of setting the substrate between opposed electrodes under a pressure close to the atmospheric pressure, and then generating corona or plasma to treat the surface of the substrate therewith, and the method of causing a gas to flow into the gap between opposed electrodes, making the gas into plasma between the electrodes, and blowing the plasma-state gas onto the substrate. Usually, these surface treatments with corona or plasma can be conducted in a commercially available surface treatment apparatus.

Examples of the method for forming an orientation layer on the substrate include a method of coating an orienting polymer onto the surface of the substrate and drying it; a method of coating an orienting polymer, drying it, and rubbing the surface thereof; a method of coating a photo-orienting polymer, drying it, and irradiating it with polarized light; a method of vapor-depositing silicon oxide obliquely; a method of forming a monomolecular film having a long chain alkyl group using the Langmuir-Blodgett method (LB method); and the like. Among them, from the viewpoint of orientation uniformity of the polymerizable liquid crystal compound set forth below, and treatment time and treatment cost of production of the laminated body of the present invention, preferred are the method of coating an orienting polymer and drying it, and the method of coating an orienting polymer, drying it, and rubbing the surface thereof.

The orienting polymer and the photo-orienting polymer are usually dissolved in a solvent and coated.

The orientation layer herein is preferably a layer that does not dissolve in the composition for forming an optically anisotropic layer, is not deteriorated by removing the solvent contained in the composition for forming an optically anisotropic layer and heating for adjusting liquid crystal orientation of the polymerizable liquid crystal compound, and does not cause peeling due to friction or the like during transporting the film.

Examples of the orienting polymer include polyamides and gelatins, which each have amide bonds in the molecule, polyimides, which each have imide bonds in the molecule, polyamic acids, which are each a hydrolyzate of a polyimide, polyvinyl alcohols, alkyl-modified polyvinyl alcohols, polyacrylamides, polyoxazoles, polyethyleneimines, polystyrenes, polyvinyl pyrrolidones, polyacrylic acids, polyacrylates, and the like. These polymers may be one kind, a composition obtained by combining plural kinds of polymers, or a copolymer obtained by combining plural kinds of polymers. Among them, preferred is preferably polyamide, polyimide or a polyamic acid. These polymers can be easily produced by polycondensation such as dehydration and deamination, chain polymerization such as radical polymerization, anion polymerization and cation polymerization, coordination polymerization, ring-opening polymerization or the like.

Examples of the commercially available orienting polymer include products SUNEVER (registered trademark, manufactured by Nissan Chemical Industries, Ltd.), OPTMER (registered trademark, manufactured by JSR Corporation), and the like.

The orientation layer composed of such orienting polymer facilitates the liquid crystal orientation of the polymerizable liquid crystal compound. In accordance with the kind of the orienting polymer, or rubbing conditions, various liquid crystal orientations such as horizontal orientation, vertical orientation, hybrid orientation and oblique orientation can be controlled, and can be utilized for improvement of a viewing angle of various liquid crystal panels, and the like.

The photo-orienting polymer includes a polymer having a photosensitive structure. When the polymer having a photosensitive structure is irradiated with polarized light, the photosensitive structure in the irradiated portion is isomerized or crosslinked such that the photo-orienting polymer is oriented, and orientation regulating force is given to a layer made of the photo-orienting polymer. Examples of the photosensitive structure include an azobenzene structure, a maleimide structure, a chalcone structure, a cinnamic acid structure, a 1,2-vinylene structure, a 1,2-acetylene structure, a spiropyran structure, a spirobenzopyrane structure, a fulgide structure, and the like. The photo-orienting polymer forming an orientation layer may be one kind, a combination of a plurality of polymers having different structures, or a copolymer having a plurality of different photosensitive structures. The photo-orienting polymer can be produced by polycondensation such as dehydration and dealcoholization, chain polymerization such as radical polymerization, anion polymerization and cation polymerization, coordination polymerization, ring-opening polymerization or the like, of a monomer having a photosensitive structure. Examples of the photo-orienting polymer include photo-orienting polymers described in Japanese Patent Nos. 4450261 and 4011652, JP-A-2010-49230, Japanese Patent No. 4404090, JP-A-2007-156439, JP-A-2007-232934, and the like. Among them, as the photo-orienting polymer, a polymer forming crosslinked structure by polarized light irradiation is preferred, from the viewpoint of durability.

Examples of the solvent to dissolve an orienting polymer or photo-orienting polymer include water; alcohol solvents such as methanol, ethanol, ethylene glycol, isopropyl alcohol, propylene glycol, methylcellosolve, and butylcellosolve; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, methyl isobutyl ketone, and N-methyl-2-pyrrolidone; aliphatic hydrocarbon solvents such as pentane, hexane, and heptane; aromatic hydrocarbon solvents such as toluene, xylene, and chlorobenzene; nitrile solvents such as acetonitrile; ether solvents such as propylene glycol monomethyl ether, tetrahydrofuran, and dimethoxyethane; halogenated hydrocarbon solvents such as chloroform; and the like. Such organic solvents may be used alone or in combination.

The amount of the solvent is usually 10 parts by mass to 100000 parts by mass, preferably 1000 parts by mass to 50000 parts by mass, and more preferably 2000 parts by mass to 20000 parts by mass, related to 100 parts by mass of the orienting polymer or photo-orienting polymer.

Examples of the method for dissolving an orienting polymer or photo-orienting polymer in a solvent and coating it onto the substrate include extrusion coating, direct gravure coating, reverse gravure coating, CAP coating, die coating methods, and the like. Also, examples include a method of coating using a coater such as a dip coater, a bar coater, or a spin coater.

Examples of the drying method include natural drying, ventilation drying, heat drying, and reduced-pressure drying; and any combination of these methods. The drying temperature is preferably from 10° C. to 250° C., and more preferably from 25° C. to 200° C. The drying time, which depends on the kind of the solvent, is preferably from 5 seconds to 60 minutes, and more preferably from 10 seconds to 30 minutes.

Examples of the method for the rubbing include a method of bringing a rotating rubbing-cloth-wound rubbing roll into contact with the orienting polymer coated onto the substrate and dried.

Examples of the method for irradiating polarized light include a method using a device described in JP-A-2006-323060. In addition, a patterned orientation layer can be also formed by repeatedly irradiating each region with polarized light such as linear polarized ultraviolet rays, via photomask corresponding to a plurality of desired regions. As the photomask, one provided with a shielding pattern on a film such as quartz glass, soda lime glass or polyester is usually used. In the portion covered with the shielding pattern, polarized light to be irradiated is shielded, and in the portion not being covered, polarized light to be irradiated is transmitted. Quartz glass is preferred in that the influence of thermal expansion is small. The polarized light to be irradiated is preferably ultraviolet ray, from the viewpoint of reactivity of the photo-orienting polymer.

The thickness of the orientation layer is usually from 10 nm to 10000 nm, and preferably from 10 nm to 1000 nm.

It is preferred when the thickness of the orientation layer is in the above range, since the polymerizable liquid crystal compound can be easily liquid-crystal-oriented in the desired direction or angle.

An optically anisotropic film is obtained by coating the composition for forming an optically anisotropic layer onto the surface of the orientation layer to polymerize polymerizable liquid crystal compound contained in the composition for forming an optically anisotropic layer, or coating and drying to polymerize polymerizable liquid crystal compound contained in the composition for forming an optically anisotropic layer. When the optically anisotropic film exhibits a liquid crystal phase such as a nematic phase, the film has a birefringence property based on mono-domain orientation. In the optically anisotropic film of the present invention, the liquid crystal orientation of the polymerizable liquid crystal compound is fixed so that the film is hardly affected by a birefringence change by heat.

The thickness of the optically anisotropic film can be properly adjusted depending on its use, and is preferably from 0.1 μm to 10 μm, and is further preferably from 0.2 μm to 5 μm to make the optically anisotropic film small in photoelasticity.

Examples of the optically anisotropic film include a retardation film, a polarization film, and the like.

Polymerizable liquid crystal compound are vertically or horizontally oriented to be polymerized, whereby a retardation film can be obtained. The vertical orientation denotes that the liquid crystal compound have a long axis thereof in a vertical direction relative to the substrate surface, and the horizontal orientation denotes that the liquid crystal compound have a long axis thereof in a parallel direction relative to the substrate surface.

The liquid crystal orientation of the polymerizable liquid crystal compound is controlled by respective properties of the orientation layer and the polymerizable liquid crystal compound. For attaining vertical orientation, it is preferred to select polymerizable liquid crystal compound that are vertically oriented with ease, and an orientation layer that causes the polymerizable liquid crystal compound to be vertically oriented.

When the orientation layer is made of, for example, a material having orientation regulating force that expresses horizontal orientation, the polymerizable liquid crystal compound can form horizontal orientation or hybrid orientation. When the orientation layer is made of a material having orientation regulating force that expresses vertical orientation, the polymerizable liquid crystal compound can form vertical orientation or oblique orientation.

When the orientation layer is composed of, for example, an orienting polymer, the orientation regulating force is optionally adjustable in accordance with the surface state or rubbing conditions. When the orientation layer is composed of a photo-orienting polymer, the orientation regulating force is optionally adjustable in accordance with polarized-light-irradiating conditions and the like. The liquid crystal orientation is also controllable by selecting physical properties such as surface tension and liquid crystal property of the polymerizable liquid crystal compound.

Examples of the method for coating the composition for forming an optically anisotropic layer onto the orientation layer include extrusion coating, direct gravure coating, reverse gravure coating, CAP coating, slit coating, die coating methods, and the like. Also, examples include a method of coating using a coater such as a dip coater, a bar coater or a spin coater, and the like. Among them, preferred are CAP coating, inkjet coating, dip coating, slit coating, die coating, and bar-coater-used coating methods since these methods make it possible to attain the coating continuously in a roll-to-roll manner. When this composition is coated in a roll-to-roll manner, it is allowable to form an orientation layer by coating an orienting polymer or photo-orienting polymer onto the substrate, and further form the optically anisotropic film continuously on the obtained orientation layer.

Examples of the drying method include the same method as the drying method in forming the orientation layer. Among them, preferred are natural drying and heat drying. The drying temperature is usually in the range of 0° C. to 250° C., preferably in the range of 50° C. to 220° C., and more preferably in the range of 80° C. to 170° C. The drying time is usually from 10 seconds to 60 minutes, and preferably from 30 seconds to 30 minutes.

The method for polymerizing the polymerizable liquid crystal compound is preferably a photopolymerization method. According to the photopolymerization method, the compound can be polymerized at a low temperature, thus it is preferable from the viewpoint of the heat resistance of the substrate. The photopolymerization reaction is usually conducted by the irradiation of visible rays, ultraviolet rays, or a laser ray, and preferred is ultraviolet rays.

Photoirradiation is preferably performed after drying to remove the solvent contained in the coated composition for forming an optically anisotropic layer. The drying may be performed simultaneously with photoirradiation. It is however preferred to remove almost all of the solvent before performing photoirradiation.

When an orientation layer is formed on the substrate, an optically anisotropic film is formed on the surface of the orientation layer, thereby obtaining a laminated body having the substrate, the orientation layer and the optically anisotropic film, in this order. The laminated body of the present invention is excellent in transparency in a visible light region, thus is useful as a member for various display devices.

Also, the substrate or the substrate and the orientation layer may be removed from the laminated body.

The optically anisotropic film not having the substrate, or the substrate and the orientation layer, is usually combined with other member such as a polarization film via an adhesive.

Examples of the method for combining with other member via an adhesive include a method of bonding the optically anisotropic film not having the substrate, or the substrate and the orientation layer, onto other member using an adhesive; a method of bonding the optically anisotropic film formed on the surface of the orientation layer formed on the surface of the substrate, onto other member using an adhesive, then removing the substrate, or the substrate and the orientation layer; and the like. At this time, the adhesive may be coated onto the optically anisotropic film, and may be coated onto other member.

The arithmetic average roughness of the surface of the optically anisotropic film of the present invention is usually 100 nm or less, preferably 50 nm or less, more preferably 40 nm or less, and further preferably 30 nm or less.

The arithmetic average roughness (Ra) can be calculated using an attached software, for example, in a cross-sectional observation using a commercially available laser microscope, and the arithmetic average roughness (Ra) herein is obtained by setting a cutoff wavelength in the parameter calculation to 1/50 of the visual field width of the image, and calculating a reference length as the visual field width of the image.

Specifically, the arithmetic average roughness (Ra) is calculated according to the following equation:

$$Ra = \frac{1}{𝓁} {\int }_{0}^{𝓁} \vert f ( x ) \vert d x$$

wherein Ra represents arithmetic average roughness, l represents a reference length, and f(x) represents a roughness curve.

Namely, when only the reference length is cut out from the roughness curve in the direction of its average line, the x-axis was taken in the direction of the average line of the cut out portion, and the y-axis was taken in the direction of the vertical magnification of the cross section, then the arithmetic average roughness (Ra) is obtained when the roughness curve is expressed as y=f(x).

The laminated body of the present invention is laminated in a plural number, the laminated body of the present invention is combined with other film, or the optically anisotropic film of the present invention is combined with other member, whereby the laminated body can be used as a viewing angle compensating film, a viewing angle enlarging film, an anti-reflection film, a polarizing plate, a circularly polarizing plate, an elliptically polarizing plate, or a brightness enhancement film.

The optically anisotropic film of the present invention that is a retardation film, and the laminated body having an optically anisotropic film are particularly useful as an optical material for converting a linearly polarized light when confirming from the oblique angle of a light emission side to a circularly polarizing light or an elliptically polarizing light, converting a circularly polarizing light or an elliptically polarizing light to a linearly polarized light, and converting the polarization direction of a linearly polarized light.

The optically anisotropic film of the present invention that is a retardation film, and the laminated body having an optically anisotropic film are usable as a retardation film for various liquid crystal display devices in a vertical alignment (VA) mode, an in-plane switching (IPS) mode, an optically compensated bend (OCB) mode, a twisted nematic (TN) mode, a super twisted nematic (STN) mode, and the like.

When the refractive index in the in-plane slow axis direction thereof is represented by nₓ, that in the direction orthogonal to the in-plane slow axis (the fast axis direction) by n_{y}, and that in the thickness direction thereof by n_{z}, the optically anisotropic film and laminated body of the present invention can be classified as follows. The optically anisotropic film and laminated body of the present invention are particularly preferably used as a positive C plate.

a positive A plate in which nₓ>n_{y}≈n_{z},
a negative C plate in which nₓ≈n_{y}>n_{z},
a positive C plate in which nₓ≈n_{y}<n_{z}, and
a positive O plate and a negative O plate in which nₓ≠n_{y}≠n_{z}

When the optically anisotropic film and laminated body of the present invention are used as a positive C plate, it is advisable to adjust the front retardation value Re(549) into the range of 0 nm to 10 nm, and preferably into the range of 0 nm to 5 nm, and adjust the retardation value Rₜₕ in thickness direction into the range of −10 nm to −300 nm, and preferably into the range of −20 nm to −200 nm. It is particularly preferred to properly select these values in accordance with properties of the liquid crystal cell.

The retardation value Rₜₕ in thickness direction, which means the refractive index anisotropy of the optically anisotropic film in the thickness direction, can be calculated from the retardation value R₅₀ measured in the state of inclining the in-plane fast axis at 50 degrees to be rendered an inclined axis, and the in-plane retardation value R_{D}. Specifically, the retardation value Rₜₕ in thickness direction can be calculated by obtaining nₓ, n_{y} and n_{z} through the following equations (9) to (11) from the in-plane retardation value R_{c}, the retardation value R₅₀ which is measured in the state of inclining the fast axis at 50 degrees to be rendered an inclined axis, the thickness d of the retardation film, and the average refractive index n₀ of the retardation film; and then substituting these values into an equation (8).

Rₜₕ=[(nₓ+nᵥ)/2−n_{z}]×d (8)

R₀=(nₓ−n_{y})×d (9)

R₅₀=(nₓ−n_{y}′)×d/cos(φ) (10)

(nₓ+n_{y}+n_{z})/3=n₀ (11)

wherein

φ=sin⁻¹[sin(50°)/n₀]

n_{y}′=n_{y}×n_{z}/[n_{y}²×sin²(φ)+n₂×cos²(φ)]^{1/2}

The optically anisotropic film and laminated body of the present invention are also useful as a member which constitutes a polarizing plate.

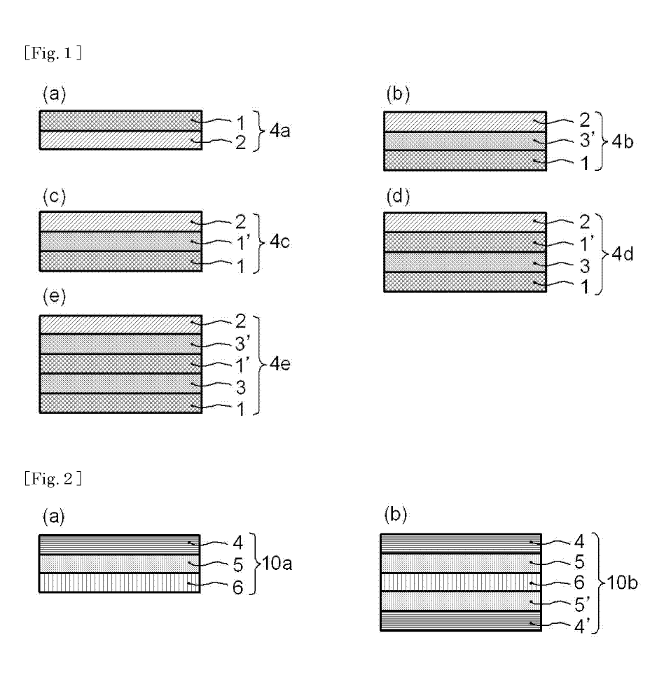

Specific examples of the polarizing plate include polarizing plates illustrated in FIGS. 1(a) to 1(e). The polarizing plate 4a illustrated in FIG. 1(a) is a polarizing plate in which a retardation film 1 and a polarization film 2 are laminated directly onto each other. The polarizing plate 4b illustrated in FIG. 1(b) is a polarizing plate in which a retardation film 1 and a polarization film 2 are stuck through an adhesive layer 3′. The polarizing plate 4c illustrated in FIG. 1(c) is a polarizing plate in which retardation films 1 and 1′ are laminated onto each other and further a polarization film 2 is laminated onto the retardation film 1′. The polarizing plate 4d illustrated in FIG. 1(d) is a polarizing plate in which retardation films 1 and 1′ are bonded onto each other through an adhesive layer 3, and further a polarization film 2 is laminated onto the retardation film 1′. The polarizing plate 4e illustrated in FIG. 1(e) is a polarizing plate in which retardation films 1 and 1′ are bonded onto each other through an adhesive layer 3, and further the retardation film 1′ and a polarization film 2 are bonded onto each other through an adhesive layer 3′. The adhesive herein denotes a generic name of any adhesive and/or any pressure-sensitive adhesive.

The retardation film and polarization film may have or may not have a substrate. The optically anisotropic film and laminated body of the present invention in which the optically anisotropic film is a retardation film can be used for retardation films 1 and 1′, and the optically anisotropic film and laminated body of the present invention in which the optically anisotropic film is a polarization film can be used for a polarization film 2.

It is sufficient for the polarization film 2 to be a film having a polarizing function. Examples of the polarization film include a drawn film to which a dye having absorption anisotropy is adsorbed, a film onto which a dye having absorption anisotropy is coated, and the like. Examples of the dye having absorption anisotropy include dichroic dyes such as iodine and azo compounds.

Examples of the drawn film to which a dye having absorption anisotropy is adsorbed include a film obtained by adsorbing a dichroic dye to a polyvinyl alcohol-based film, and then drawing the resultant; and a film obtained by drawing a polyvinyl alcohol-based film, and then adsorbing a dichroic dye to the resultant, and specific examples thereof include polarization films described in Japanese Patent No. 3708062 and Japanese Patent No. 4432487, and the like.

Examples of the film onto which a dye having absorption anisotropy is coated include a film obtained by coating a composition containing a dichroic dye having liquid crystal property, or coating a composition containing a dichroic dye and polymerizable liquid crystal compound, and specific examples thereof include polarization films described in JP-A-2012-33249, and the like.

The polarization film preferably has a protection film on one surface or both surfaces thereof. Examples of the protection film include those identical to the above-mentioned substrate.

The adhesive that forms the adhesive layers 3 and 3′ is preferably an adhesive with high transparency and excellent heat resistance. Examples of such adhesive include acrylic-based, epoxy-based and urethane-based adhesives.

The optically anisotropic film and laminated body of the present invention are usable in a display device. Examples of the display device include a liquid crystal display device equipped with a liquid crystal panel in which the optically anisotropic film or laminated body of the present invention and a liquid crystal panel are stuck with each other, and an organic electroluminescence (hereinafter also referred to as “EL”) display device equipped with an organic EL panel in which the optically anisotropic film or laminated body of the present invention and a luminous layer are stuck with each other. A liquid crystal display device will be described as an embodiment of the display device equipped with a polarizing plate having the optically anisotropic film or laminated body of the present invention.

Examples of the liquid crystal display device include liquid crystal display devices 10a and 10b illustrated in FIGS. 2(a) and 2(b), respectively. In the liquid crystal display device 10a illustrated in FIG. 2 (a), the polarizing plate 4 of the present invention and a liquid crystal panel 6 are stuck through an adhesion layer 5. In the liquid crystal display device 10b illustrated in FIG. 2 (b), the polarizing plate 4 of the present invention is stuck to one surface of a liquid crystal panel 6 through an adhesion layer 5 while a polarizing plate 4′ of the present invention is stuck to the other surface of the liquid crystal panel 6 through an adhesion layer 5′. Electrodes not illustrated are used in these liquid crystal display devices to apply a voltage to their liquid crystal panel to change the orientation of liquid crystal molecules. In this way, a monochrome display can be realized.

### EXAMPLES

Hereinafter, the present invention will be more specifically described by way of examples. In the examples, the symbol “I” and the word “part(s)” denote “% by mass” and “part(s) by mass”, respectively, unless otherwise specified.

### [Preparation of Composition for Orientation Layer]

The composition is shown in Table 1. Additive LR9000 was added to a solution obtained by adding γ-butyrolactone (GBL) and butyl acetate to SUNEVER SE-610 (manufactured by Nissan Chemical Industries, Ltd.) (orienting polymer) to yield a composition for forming an orientation layer (1).

TABLE 1

| | | | | Reactive |
|---|---|---|---|---|
| | SUNEVER SE-610 | | Butyl | additive |
| | orienting polymer | GBL | acetate | LR-9000 |
| Composition for | 0.32 g | 30.2 g | 1.5 g | 0.2 g |
| forming an | (1.0%) | (93.6%) | (4.8%) | (0.6%) |
| orientation | | | | |
| layer (1) | | | | |

The value in parentheses in Table 1 represents the proportion of each component in the prepared composition. About the SE-610, the solid content was obtained by conversion from the concentration described in a delivery specification thereof.

LR9000 in Table 1 represents Laromer (registered trademark) LR-9000 manufactured by BASF Japan Ltd.

### [Preparation of Composition for Forming an Optically Anisotropic Layer]

The individual components shown in Table 2 were mixed, and the resultant solution was stirred at 80° C. for 1 hour, and then cooled to room temperature to yield compositions for forming an optically anisotropic layer (1) to (6). Liquid crystal compounds (X-1) were produced by the method described in JP-A-2010-1284.

TABLE 2

| | Liquid | Photopoly- | | | |
|---|---|---|---|---|---|
| | crystal | merization | Leveling | Reactive | |
| | compounds | initiator | agent | additive | Solvent |
| Composition for | X-1 | Irg369 | BYK361N | LR-9000 | 2-Methoxyethyl |
| forming an optically | (19.2%) | (0.6%) | (0.1%) | (1.1%) | acetate |
| anisotropic layer (1) | | | | | boiling point of |
| | | | | | 143° C., vapor pressure |
| | | | | | of 0.27 kPa (79.0%) |
| Composition for | X-1 | Irg369 | BYK361N | LR-9000 | 2-Ethoxyethyl acetate |
| forming an optically | (19.2%) | (0.6%) | (0.1%) | (1.1%) | boiling point of |
| anisotropic layer (2) | | | | | 156° C., vapor pressure |
| | | | | | of 0.27 kPa (79.0%) |
| Composition for | X-1 | Irg369 | BYK361N | LR-9000 | Ethyl acetoacetate |
| forming an optically | (19.2%) | (0.6%) | (0.1%) | (1.1%) | boiling point of |
| anisotropic layer (3) | | | | | 184° C., vapor pressure |
| | | | | | of 0.1 kPa (79.0%) |
| Composition for | X-1 | Irg369 | BYK361N | None | Methyl ethyl ketone |
| forming an optically | (19.2%) | (0.6%) | (0.1%) | | boiling point of |
| anisotropic layer (4) | | | | | 79° C., vapor pressure |
| | | | | | of 10.5 kPa (80.1%) |
| Composition for | X-1 | Irg369 | BYK361N | LR-9000 | Methyl ethyl ketone |
| forming an optically | (19.2%) | (0.6%) | (0.1%) | (1.1%) | boiling point of |
| anisotropic layer (5) | | | | | 79° C., vapor pressure |
| | | | | | of 10.5 kPa (79.0%) |
| Composition for | X-1 | Irg369 | BYK361N | LR-9000 | Butyl acetate |
| forming an optically | (19.2%) | (0.6%) | (0.1%) | (1.1%) | boiling point of |
| anisotropic layer (6) | | | | | 126° C., vapor pressure |
| | | | | | of 1.2 kPa (79.0%) |

The value in parentheses in Table 2 represents the proportion of each component in the prepared composition. In Table 2, Irg369 represents IRGACURE 369 manufactured by BASF Japan Ltd.; BYK-361N represents a leveling agent manufactured by BYK Japan K.K.; and X-1 represents polymerizable liquid crystal compound represented by the following formula (X-1).

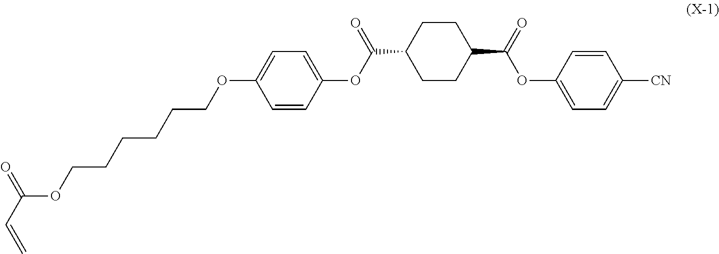

### Example 1

The surface of a cycloolefin polymer film (Arton (registered trademark), manufactured by JSR Corporation) was once treated using a corona treating apparatus (AGF-B10, manufactured by Kasuga Electric Works Ltd.) at a power of 0.3 kW and a treating rate of 3 m/minute.

The composition for forming an orientation layer (1) was coated onto the corona-treated surface and dried to form an orientation layer with a thickness of 60 nm. The composition for forming an optically anisotropic layer (1) was coated onto the surface of the resultant orientation layer using a bar coater, and heated to 105° C. to form an unpolymerized film on the orientation layer. After cooling to room temperature, Unicure (VB-15201BY-A, manufactured by USHIC INC.), the workpiece was irradiated with ultraviolet rays at a wavelength of 365 nm and an illuminance of 40 mW/cm² for 30 seconds to obtain a laminated body (1).

### Example 2, Example 3, Comparative Example 1, Comparative Example 2, and Comparative Example 3

Laminated bodies (2) to (5) were obtained by performing in the same conditions as in Example 1 except that the composition for forming an optically anisotropic layer (1) in Example 1 was changed to the composition for forming an optically anisotropic layer (2), the composition for forming an optically anisotropic layer (3), the composition for forming an optically anisotropic layer (4), the composition for forming an optically anisotropic layer (5), or the composition for forming an optically anisotropic layer (6).

### [Transparency Evaluation]

The haze value of each of the laminated bodies (1) to (6) was measured by a double beam method, using a haze meter (model: HZ-2) manufactured by Suga Test Instruments Co., Ltd. The results are shown in Table 3.

### [Optical Property Measurement]

The orientation direction of the polymerizable liquid crystal compound after polymerization contained in the laminated bodies (1) to (6) was measured using a measuring instrument (KOBRA-WR, manufactured by Oji Scientific Instruments). The measurement was made while the incident angle of light into the sample was varied, and it was checked whether or not its liquid crystals were vertically oriented.

### [Measurement of Arithmetic Average Roughness]

The arithmetic average roughness of the surface of the optically anisotropic film was calculated using a laser microscope (LEXT, manufactured by Olympus Corporation) (objective lens: 100 times). The results are shown in Table 3.

### [Adhesion Evaluation]

The peeling resistance between the orientation layer and the optically anisotropic film of the laminated bodies (1) to (6) was evaluated according to JIS-K5600, using a Cross-Cut Guide I Series device (CCI-1; a device for 25 squares having intervals of 1 mm) manufactured by COTEC CORPORATION. After the peeling test, the result of counting the remaining number of the laminated body of the orientation layer held without being peeled and the optically anisotropic film is shown in Table 3.

TABLE 3

| | | | Arithmetic | | |
|---|---|---|---|---|---|
| | | | average | Remaining | |
| | Laminated | | roughness | number after | Haze |
| | body | Orientation | (nm) | peeling test | (%) |
| Example 1 | Laminated | Vertical | 41 | 25/25 | 0.24 |
| | body (1) | orientation | | | |
| Example 2 | Laminated | Vertical | 32 | 25/25 | 0.62 |
| | body (2) | orientation | | | |
| Example 3 | Laminated | Vertical | 28 | 25/25 | 0.34 |
| | body (3) | orientation | | | |
| Comparative | Laminated | Vertical | 128 | 0/0 | 3.42 |
| example 1 | body (4) | orientation | | | |
| Comparative | Laminated | Vertical | 114 | 25/25 | 2.98 |
| example 2 | body (5) | orientation | | | |
| Comparative | Laminated | Vertical | 109 | 25/25 | 2.20 |
| example 3 | body (6) | orientation | | | |

The laminated bodies yielded in Examples were excellent in transparency.

### INDUSTRIAL APPLICABILITY

According to the present invention, an optically anisotropic film and a laminated body which are excellent in transparency can be obtained.

### DESCRIPTION OF REFERENCE SIGNS

1, 1′: Retardation film
2, 2′: Polarization film
3, 3′: Adhesive layer
4a, 4b, 4c, 4d, 4e, 4, 4′: Polarizing plate
5, 5′: Adhesion layer
6: Liquid crystal panel
10a, 10b: Liquid crystal display device

1. A composition for forming an optically anisotropic layer comprising polymerizable liquid crystal compound, a photopolymerization initiator, and an ester solvent with a boiling point of 120° C. to 200° C. and a vapor pressure of 0.7 kPa or less.

2. The composition for forming an optically anisotropic layer according to claim 1, wherein the ester solvent is at least one kind selected from the group consisting of 2-methoxyethyl acetate, 2-ethoxyethyl acetate, and ethyl acetoacetate.

3. The composition for forming an optically anisotropic layer according to claim 1, wherein the content of the ester solvent is from 10% by mass to 95% by mass, related to the composition for forming an optically anisotropic layer.

4. The composition for forming an optically anisotropic layer according to claim 1, further comprising a compound having an isocyanate group.

5. An optically anisotropic film obtained by coating the composition for forming an optically anisotropic layer according to claim 1 onto the surface of the orientation layer to polymerize the polymerizable liquid crystal compound contained in the composition for forming an optically anisotropic layer.

6. The optically anisotropic film according to claim 5, which is a retardation film.

7. The optically anisotropic film according to claim 5, wherein the arithmetic average roughness of the surface is 100 nm or less.

8. The optically anisotropic film according to claim 5, which is for an in-plane switching (IPS) liquid crystal display device.

9. A polarizing plate having the optically anisotropic film according to claim 5.

10. A display device comprising the optically anisotropic film according to claim 5.

11. A laminated body having a substrate, an orientation layer, and the optically anisotropic film according to claim 5, in this order.

12. The laminated body according to claim 11, wherein the substrate is a polyolefin resin.

13. A method for producing a laminated body comprising coating the composition for forming an optically anisotropic layer according to claim 1 onto the surface of an orientation layer of a substrate with the orientation layer, drying, and photoirradiating the composition for forming an optically anisotropic layer.

14. A polarizing plate having the laminated body according to claim 11

15. A display device comprising the laminated body according to claim 11.
